(19) United States
(12) Patent Application Publication
(10) Pub. No.: US 2003/0158933 A1
(43) Pub. Date: Aug. 21, 2003

(54) Failover clustering based on input/output processors

(76) Inventor: Hubbert Smith, Sandy, UT (US)

Correspondence Address: Pillsbury Winthrop LLP, Intellectual Property Group, Suite 2800, 725 South Figueroa Street, Los Angeles, CA, 90017-5406, US

(21) Appl. No.: 10/044,444

(22) Filed: Jan. 10, 2002

(51) Int. Cl. H04L 1/22; G06F 15/173

(52) U.S. Cl. 709/224; 714/4

(57) ABSTRACT

A network system includes a server system having a server input/output processor to monitor the server system and to issue a server down message when the server system is down. A storage array is provided having a storage array input/output processor to monitor the storage array and to issue a storage array down message when the storage array is down. A storage router interconnects the server system and the storage array. The storage router has a storage router input/output processor to monitor the storage router and to issue a storage router down message when the storage router is down. The server system and the storage array each have a cluster management information base (MIB).

### BACKGROUND OF THE INVENTION

1. Field of the Invention

The present invention generally relates to a network cluster. More particularly, the present invention relates to an input/output processor for use in server systems and storage arrays utilized in a network cluster architecture having a configuration which reduces cost and complexity to implement.

2. Discussion of the Related Art

Multiple computer systems (e.g., server systems), multiple storage devices (such as storage arrays), and redundant interconnections may be used to form what appears to be a single highly-available system. This arrangement is known as “clustering”. Clustering may be utilized for load balancing, as well as providing high availability for a network system.

Current clustering implementations are typically accomplished with software executing on an operating system. Clusters, such as the Microsoft Cluster Server (MSCS), use one server to monitor the health of another server. This monitoring arrangement requires dedicated local area network (LAN) network interface cards (NICs), as well as cabling and hubs for handling “heartbeat” traffic. A “heartbeat” is a message transmitted by a system having therein parameters of the system, such as, whether it is active or down, its available memory, central processing unit (CPU) loading and CPU response parameters, storage subsystem responses, and application responses.

FIG. 1 illustrates a prior art traditional network clustering implementation utilizing Small Computer Systems Interface (SCSI) connections. Each server has at least two connections, one to a router or hub, and the other to a storage array. The host bus adapter (HBA) on each of the servers has a SCSI connection to an array controller of a storage array. The heartbeat NIC (e.g., an Ethernet card) on each of the servers has a connection to the router or hub. The connections from the heartbeat NICs to the router or hub form a dedicated LAN for heartbeat traffic between the servers.

In a traditional clustering implementation as illustrated in FIG. 1, such as with the MSCS, the cluster is not scalable past four nodes (servers). There is no ability to “hot” add or remove nodes (while the system is running). There is no support for server farms. The cluster is not particularly reliable because one server is utilized to monitor the health of all of the other servers. The overall system is burdened by having to continually create and monitor heartbeats (e.g., constant “system up” and “system down” notifications) and perform network processing tasks. There is an increased cost in utilizing a dedicated heartbeat LAN due to the additional hardware and cabling required. The existence of the heartbeat LAN also increases the complexity of the system.

FIG. 2 illustrates a prior art fiber channel-based network clustering implementation. Similar to the implementation in FIG. 1, each server has at least two connections, one to a router or hub, and one to a fiber channel switch. The fiber channel switch connects to storage arrays on the other end via an array controller on each storage array. The host bus adapter (HBA) on each of the servers has a fiber channel connection to the fiber channel switch. The fiber channel switch is also connected to the array controller of each of the storage arrays via a fiber channel connection. The heartbeat NIC on each of the servers has a connection to the router or hub. The connections from the heartbeat NICs to the router or hub form a dedicated LAN for heartbeat traffic between the servers.

In the fiber channel-based network clustering implementation as illustrated in FIG. 2, it is possible to scale past four nodes and provide for server farms, but with increased cost and complexity to the overall system. The network clustering implementation of FIG. 2 is also not particularly reliable because one server monitors the health of all of the other servers. The overall system is also burdened by having to continually create and monitor heartbeats and perform network processing tasks. There is an increased cost in utilizing a dedicated heartbeat LAN due to the additional dedicated heartbeat hardware and cabling required. The existence of the heartbeat LAN also increases the complexity of the system.

Accordingly, what is needed is a network clustering implementation that is more reliable, less complex and costly, while still capable of handling health monitoring, status reporting, and failover management of the server systems and storage arrays within a network cluster.

### BRIEF DESCRIPTION OF THE DRAWINGS

FIG. 1 illustrates a traditional network clustering implementation according to the prior art;

FIG. 2 illustrates a fiber channel-based network clustering implementation according to the prior art;

FIG. 3 illustrates a network clustering implementation according to an embodiment of the present invention;

FIG. 4 illustrates cluster failure/recovery logic according to an embodiment of the present invention;

FIG. 5 illustrates cluster heartbeat and health monitoring logic according to an embodiment of the present invention;

FIG. 6 illustrates cluster node add/remove logic according to an embodiment of the present invention; and

FIG. 7 illustrates start-of-day cluster membership logic according to an embodiment of the present invention.

### DETAILED DESCRIPTION

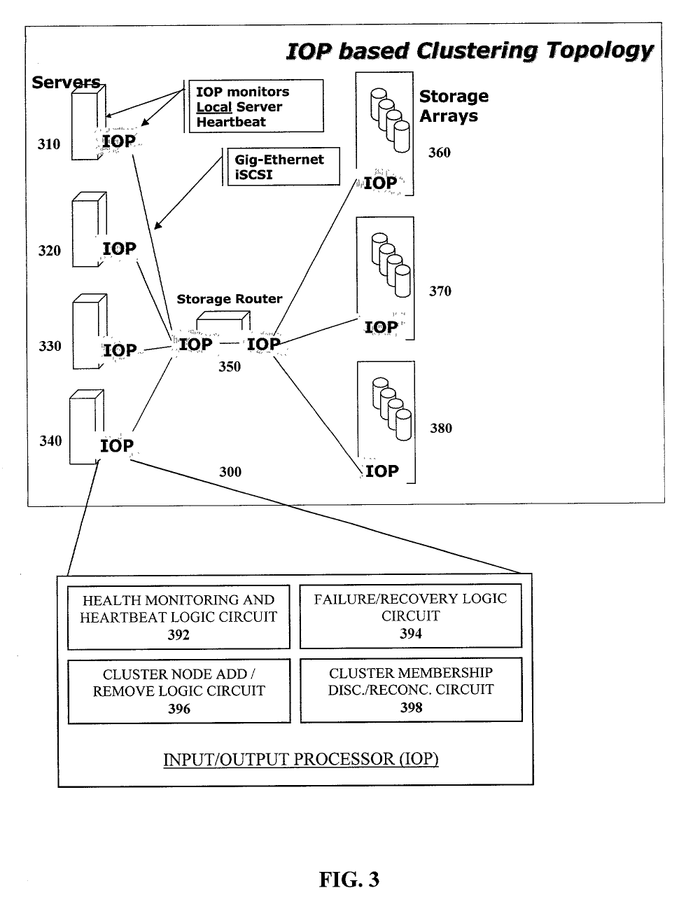

FIG. 3 illustrates a network clustering implementation according to an embodiment of the present invention. The network cluster 300 includes a plurality of server systems 310, 320, 330, 340, each having a connection with a storage router 350. The network cluster 300 also includes a plurality of storage arrays 360, 370, 380, each having a connection with the storage router 350 as well. The connections utilized are preferably Gig-Ethernet Internet Small Computer System Interface (iSCSI) connections, but, any other suitable connections may be utilized.

Each of the server systems 310, 320, 330, 340, the storage router 350, and the storage arrays 360, 370, 380 have a local input/output processor. The input/output processor, also known as an I/O processor or IOP, is a computer microprocessor, separate from a computer's central processing unit (CPU), utilized to accelerate data transfers, usually between a computer system and a hard disk storage attached thereto. Input/output processors may include a module that interfaces to an input/output bus within a computer system, such as a Peripheral Component Interconnect (PCI), a media access control (MAC) module, internal memory to cache instructions, an input/output processor module with a programming model for developing logic for redundant array of independent disks (RAID) processing, streaming media processing, etc. The input/output processors within each of the server systems 310, 320, 330, 340, the storage router 350, and the storage arrays 360, 370, 380 monitor their respective host systems. In one embodiment of the present invention, the input/output processors each run on a real-time operating system (RTOS), which is more reliable than conventional operation systems.

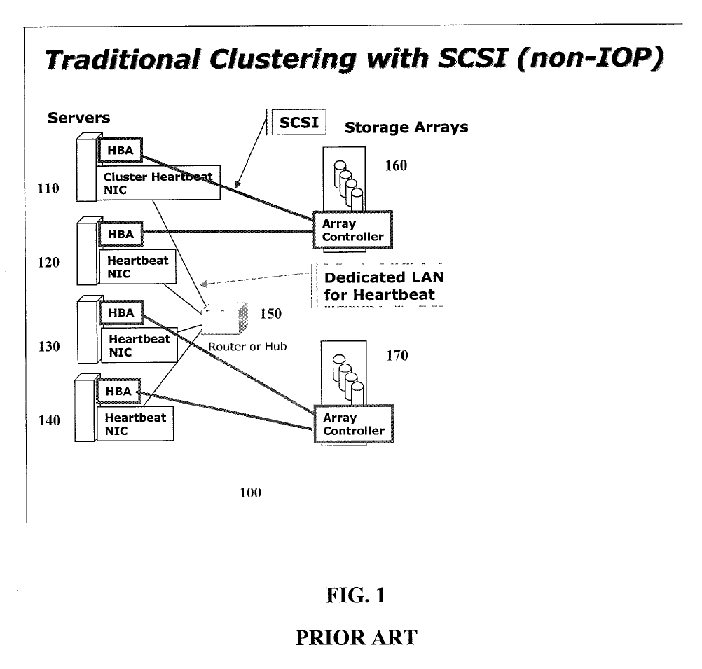

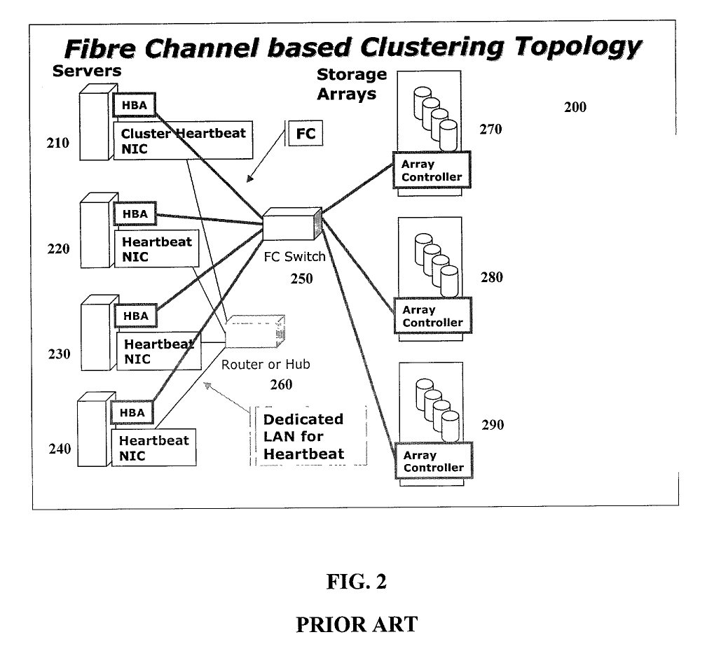

As the input/output processors monitor their respective host systems 310, 320, 330, 340, 350, 360, 370, 380, the input/output processor produces a “system down” message if a problem is encountered. But the input/output processor does not generate a steady stream of “system up” messages, which reduces the overall traffic outputted on the connections. In the systems illustrated in FIGS. 1 and 2, for example, there is constant heartbeat “chatter” as “system up” messages are continually transmitted.

The input/output processor includes a health monitoring and heartbeat logic circuit 392, a failure/recovery logic circuit 394, a cluster node add/remove logic circuit 396, and a cluster membership discovery/reconcile logic circuit 398. The health monitoring and heartbeat logic circuit monitors the host system 310, 320, 330, 340, 350, 360, 370, 380 and generates a “system down” message when the system is down. “System up” messages are not transmitted if the system is operating normally. The failure/recovery logic circuit designates status of the host system 310, 320, 330, 340, 350, 360, 370, 380, such as “active”, “failed”, “recovered”, and “standby”, and allows the system to take over for a “failed” system. That is, in most network cluster implementations, a “standby” system is typically provided to take over for an “active” system that has gone down so as to avoid a loss of performance within the network cluster. Status designations other than the four listed above may be utilized as well.

The cluster node add/remove logic circuit allows the addition or removal of systems without having to take the network cluster offline. That is, the cluster node add/remove logic circuit facilitates the ability to “hot” add or remove systems without taking the network cluster offline. The cluster membership discovery/reconcile logic circuit enables the input/output processors to establish the network cluster by identifying each of the connected systems 310, 320, 330, 340, 350, 360, 370, 380 and to ensure that cluster failover support for the connected systems is available.

Accordingly, the network clustering implementation as illustrated in FIG. 3 has a comparatively low system burden as compared to the implementations of FIGS. 1 and 2, because a dedicated LAN, along with the cables and hardware, for dedicated heartbeat traffic are not required. Moreover, data transmitted to and from the host systems 310, 320, 330, 340, 350, 360, 370, 380, along with the “system down” messages, travel along the same connections. In other words, the “system down” messages, or heartbeat traffic, do not require their own dedicated network, as in the prior art systems.

Also, the heartbeat traffic in the present invention is not as “talkative”. Because the local input/output processor monitors its respective host system 310, 320, 330, 340, 350, 360, 370, 380, rather than by a remote server, the input/output processor only needs to transmit a “system down” message when the system is down. The input/output processor need not continually transmit a steady stream of “system up” heartbeat messages, as in the prior art systems of FIGS. 1 and 2, which imposes a heavy system load for the server being monitored, along with the server doing the monitoring. Cluster implementation, heartbeat processing, and protocol processing consume a great deal of CPU cycles and memory.

The network clustering implementation of FIG. 3 enables both server systems 310, 320, 330, 340 and storage arrays (or devices) 360, 370, 380 to be configured as cluster members. Although storage arrays, such as a redundant array of independent disks (RAID), are preferred, the storage array may be a single storage device such as a hard disk drive. The failure/recovery logic circuit allows one server system 310, 320, 330, 340 or storage array 360, 370, 380, to take over for a failed system, respectively; and the cluster membership discovery/reconcile logic circuit allows the network cluster to include both server systems 310, 320, 330, 340 and storage arrays 360, 370, 380 as members of the cluster. Therefore, a single cluster topology may be utilized to manage all of the required resources within a server farm, including its storage elements.

In the prior art network cluster implementations, as in FIGS. 1 and 2, there is no storage failure management because only server systems are managed by the cluster. In other words, storage arrays are not monitored by the cluster, which could lead to system down time if a storage array failure occurred. There are some proprietary examples of storage array failure management, but these solutions are limited to a proprietary pair and focus solely on the storage side only.

Accordingly, the network clustering implementation of FIG. 3, which utilizes embedded failover clustering, is based on the premise that failover clustering may be embedded into the input/output processors within each host system 310, 320, 330, 340, 350, 360, 370, 380, and need not be executed on the operating system as a user-space process. The input/output processor of a host system 310, 320, 330, 340, 350, 360, 370, 380 handles its health monitoring, heartbeating, and failover management. The input/output processor monitors the host system's health and issues a “system down” message reliably when the host system 310, 320, 330, 340, 350, 360, 370, 380 is down, even when the host system operating system is down. The input/output processor generates “health” status (e.g., active, failed, recovered, standby, etc.) to the other input/output processors in the cluster, preferably via the Storage over Internet Protocol (SoIP). Within this cluster architecture, the dedicated LAN for heartbeating, as in FIGS. 1 and 2, are eliminated, and the heartbeat is less talkative and more reliable, which leads to a more reliable network cluster. Therefore, the cluster is easier to set up, and cluster membership is easily adaptable to support server farms.

The input/output processor is also adapted to handle administration of the network cluster, such as discovery, creation, and updating of a management information base (MIB) for each system within the network cluster. The MIB is a database containing ongoing information and statistics on each system/device (node) within the network cluster, which is utilized to keep track of each system/device's performance, and helps ensure that all systems/devices are functioning properly. That is, an MIB is a data structure and data repository for managing information regarding a computer's health, a computer's operations, and/or a computer's components. A “cluster MIB” may be provided having information about each system/device within the network cluster. A copy of the cluster MIB is stored within each node of the network cluster.

Information stored within the cluster MIB may include a cluster identification number, a date/time stamp, and floating Internet Protocol (IP) address(es) assigned to each particular cluster number. For each server node, the cluster MIB may include data regarding a cluster server node number, a node identification number, a primary IP address, floating IP address(es) assigned to the node number, and node status (e.g., active, down, standby, etc.). For each application (e.g., a software application), data may be stored within the cluster MIB regarding an application number, an application's storage volumes, executables, and IP address(es). For each storage node, the cluster MIB may include data regarding a cluster storage node number, a node identification number, a primary (e.g., iSCSI) address, floating (e.g., iSCSI) addresses assigned to the node number, node status (e.g., active, down, standby, etc.), and a storage volume number. However, other information that may be utilized to keep track of each system/device's performance within the network cluster may be included.

For example, a sample cluster MIB metadata structure may be as follows:

Cluster ID

DateTimeStamp

FloatingIPaddressesAssignedToCluster n, { }

ClusterServerNode n

NodeID

PrimaryIPaddress

FloatingIPaddressesAssignedToNode n, { }

NodeStatus {active, down, standby}

Application n,{storage volumes, executables, IP addresses}.

For example, a sample MIB structure for each node in the cluster may be as follows:

ClusterStorageNode n

NodeID

PrimaryiSCSIAddress

FloatingiSCSIAddressesAssigned n, { }

NodeStatus {active, down, standby}

StorageVolumes n,{ }

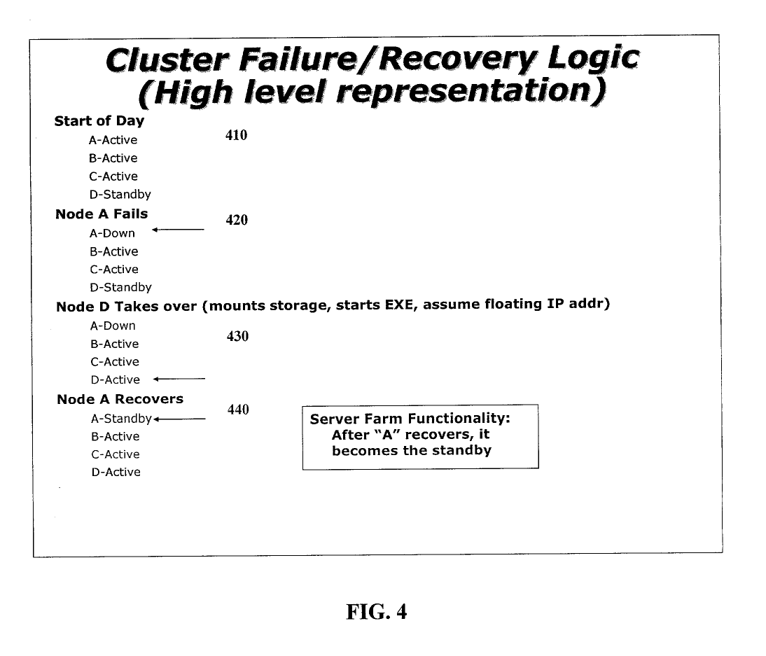

FIG. 4 illustrates cluster failure/recovery logic according to an embodiment of the present invention. In the example provided in FIG. 4, four servers (A-D) 410 are provided at the beginning of the day. Servers A-C are have an “active” status, while Server D is on “standby” status. Subsequently, Server A fails 420. Accordingly, Server A now has a “down” or “failed” status, Servers B and C still have an “active” status, and Server D is still on “standby” status.

Server D, the “standby” server, takes over 430 for “failed” Server A. Server D mounts storage, starts the executables, and assumes the floating IP address for Server A. Every application requires associated data storage and the storage physically resides on storage arrays. The operating system and application require a definition of that data storage (e.g., the SCSI disk identification, volume identification, and a directory to define a specific volume of storage used by an application). Normally, Server A accesses that storage using a “mount” command, which provides read/write access to the data volumes. If Server A has read/write access, then other nodes do not have write access. However, if Server A fails, the volumes need to be “mounted” for read/write access by the standby node (Server D).

Every application is a program (typically an “exe” file, but not always). Normally, Server A is running an application. However, if Server A fails, the same application will be required to be run on the standby node (Server D), and so Server D starts the executables.

Clients will access an application over the network, dependent upon an IP address. If Server A fails, then the standby node (Server D) assumes the floating IP address formerly assigned to Server A. In other words, the floating IP address is simply moved to another server (from Server A to Server D).

Once Server A recovers 440 later, its new status is now “standby”; and Servers B-D now have an “active” status. Therefore, when a server goes down, there is a “standby” server ready to immediately take over for the “failed” server. The failure/recovery logic circuit of the input/output processor is primarily responsible for failover management of the systems within the cluster.

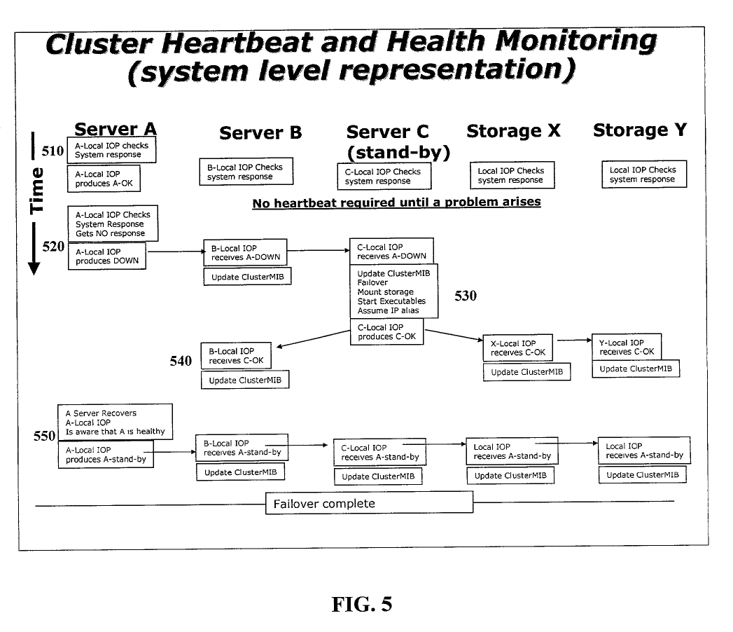

FIG. 5 illustrates cluster heartbeat and health monitoring logic according to an embodiment of the present invention. In the example of FIG. 5, three servers (A-C) are provided, and two storage arrays/devices (X and Y) are provided. Server C is designated as the “standby” server. Beginning at time 510, the local input/output processors of Servers A, B, and C, and Storage X and Y initiate a system response self-check. The local input/output processor of Server A produces an “OK” response. From Server A's perspective, it does not receive any other status reports or “heartbeats” from the other servers and storage arrays until a problem arises. At time 520, during the Server A local input/output processor's periodic system response self-check, it receives a “NO” response. Accordingly, the local input/output processor of Server A designates a “DOWN” status for Server A. This “DOWN” status message or heartbeat from Server A is forwarded to Server B, of which its local input/output processor receives the Server A “DOWN” heartbeat and updates its cluster MIB. Server C also receives the “DOWN” status heartbeat from Server A. In response, Server C, which is the “standby” server assigned to take over when an “active” server goes down, updates its cluster MIB, initiates the failover procedure, mounts storage, starts the executables, and assumes the IP address alias of Server A at time 530. The local input/output processor of Server C then produces a Server C “OK” response.

Accordingly, at time 540, the local input/output processor of Server B receives the “OK” response from Server C and updates its cluster MIB. Similarly, Storage X and Storage Y each receive the “OK” response sent from Server C, and each of Storage X and Storage Y updates their respective cluster MIBs. Later at time 550, Server A recovers and its local input/output processor is aware that it is now “healthy”. The Server A local input/output processor establishes a “standby” designation for Server A. Subsequently, the input/output processors for Servers B and C, and Storage X and Y receive the “standby” status from Server A, and each of Servers B and C, and Storage X and Y update their respective cluster MIBs indicating the same. Accordingly, Server C automatically assumed the tasks of Server A after it went down. The failover procedure is now complete for the network cluster. The health monitoring and heartbeat logic circuit of the input/output processor is primarily responsible for the cluster heartbeat and health monitoring of the systems within the cluster.

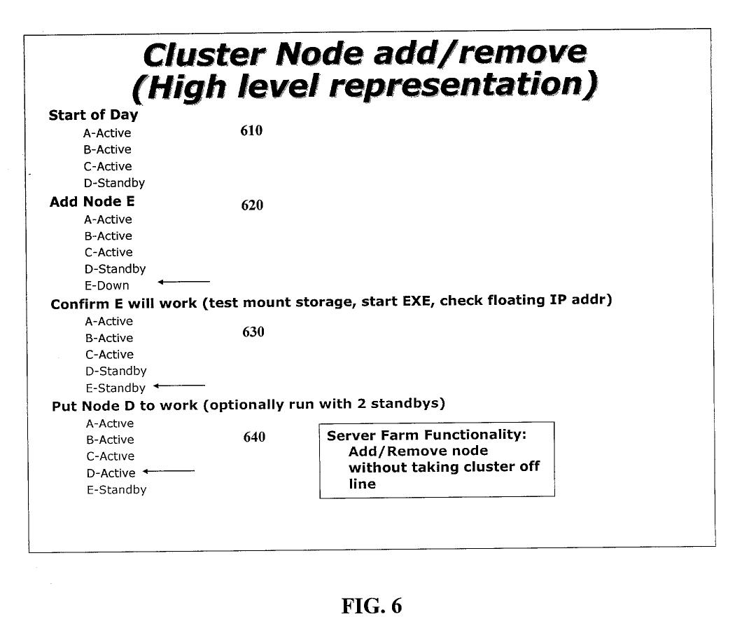

FIG. 6 illustrates cluster node add/remove logic according to an embodiment of the present invention. In the example provided in FIG. 6, four servers (A-D) 610 are initially provided. Servers A-C have an “active” status, while Server D is on “standby” status. Subsequently, new Server E is added 620 to the cluster. When Server E is first added to the cluster, its initial status is “down”. Next, Server E is tested to confirm 630 that it will function within the cluster, e.g., by testing the mount storage (confirming that the storage will be accessible if/when failover occurs), testing start of executables (confirming that the application(s) is properly installed and configured so that it will run properly if/when failover occurs), checking the floating IP address (ensuring that the floating IP address will redirect network traffic properly if/when failover occurs).

Once Server E has been confirmed to function within the cluster, its status is changed to a “standby” designation. The cluster may be configured to have two “standby” servers (Servers D and E), or one of the “standby” servers (either Server D or E) may be activated. In the example of FIG. 6, Server D is activated, and its status is changed from “standby” to “active”. Accordingly, server farm functionality of adding or removing a node without taking the cluster offline is possible. The cluster node add/remove logic circuit is primarily responsible for enabling “hot” add and remove functionality of the systems within the cluster.

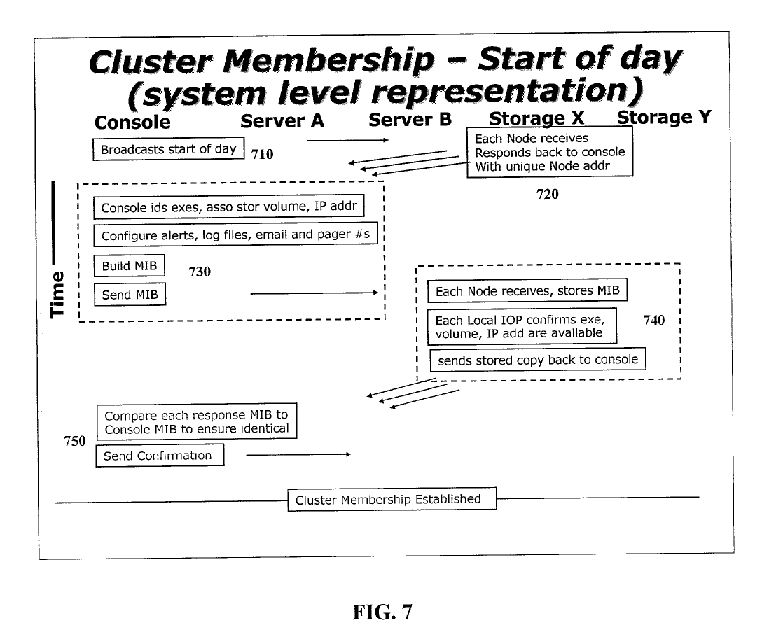

FIG. 7 illustrates start-of-day cluster membership logic according to an embodiment of the present invention. In the example provided in FIG. 7, two servers (A and B) and two storage arrays/devices (X and Y) are provided. At time 710, a console broadcasts 710 the “start of the day” message to Servers A and B and Storage X and Y. The console is a program having a user interface utilized by the cluster system administrator to initially configure the network cluster, to check the status of the cluster, and to diagnose problems with the cluster. At time 720, each node (Servers A and B and Storage X and Y) receives the broadcast and responds back to the console with a unique node address. At time 730, the console identifies the executables required, and associates the storage volume and the IP addresses of the nodes. The console also configures the alerts, log files, e-mail, and pager numbers, for example. The cluster MIB is generated and transmitted to each node. Each node receives and stores the cluster MIB at time 740. Each local input/output processor for each node also confirms whether the executables, storage volume, and IP addresses are available. A stored copy of each cluster MIB is also transmitted back to the console. At time 750, the console compares each response cluster MIB to the console cluster MIB to ensure that they are identical. A confirmation is sent to the nodes if no problems exist and the cluster membership for each node is established. The cluster membership discovery/reconcile logic circuit is primarily responsible for establishing cluster membership of the systems within the cluster.

In summary, there are a number of benefits in utilizing input/output processor based clustering according to the present invention. First, it provides a simpler implementation. No dedicated NICs or cabling are required for heartbeat traffic, which amounts to one less item to set up, troubleshoot, and maintain. Secondly, input/output processor based clustering is more reliable because the local input/output processor monitors its host's health, which is significantly more reliable than having one server monitor the health of a plurality of servers. Moreover, input/output processor based clustering is less expensive due to the lack of a dedicated NIC or cabling required for heartbeat traffic. Also, a single topology for the storage protocol and the cluster protocol is utilized. The input/output processor based clustering implementation provides a lower network load, and because the local input/output processor monitors its host system's health, the implementation requires less heartbeat-related communication over the local area network. Input/output processor based clustering has a zero system load because the local input/output processor produces the heartbeats and monitors the heartbeats, and input/output processor heartbeat creation/send/receive/monitoring do not consume CPU cycles or system memory. Input/output processor based clustering according to the present invention provides for automated membership establishment, which makes wide area clustering (i.e., geographically remote failover) feasible.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A network system, comprising:
a server system having a server input/output processor to monitor the server system and to issue a server down message when the server system is down;
a storage array having a storage array input/output processor to monitor the storage array and to issue a storage array down message when the storage array is down; and
a storage router interconnecting the server system and the storage array, the storage router having a storage router input/output processor to monitor the storage router and to issue a storage router down message when the storage router is down, wherein the server system and the storage array each have a cluster management information base (MIB).

2. The system according to claim 1, wherein data transmitted to and from the server system and the server down message travel along a connection between the server system and the storage router.

3. The system according to claim 1, wherein data transmitted to and from the storage array and the storage array down message travel along a connection between the storage array and the storage router.

4. The system according to claim 1, wherein the server system and the storage router are members of a network cluster.

5. The system according to claim 1, wherein the server system is connected to the storage router via a Gig-Ethernet Internet Small Computer System Interface (iSCSI) connection.

6. The system according to claim 1, wherein the storage array is connected to the storage router via a Gig-Ethernet Internet Small Computer System Interface (iSCSI) connection.

7. The system according to claim 1, wherein the storage router further includes a second storage router input/output processor, the storage router input/output processor being in communication with the server input/output processor, and the second router input/output processor being in communication with the storage array input/output processor.

8. The system according to claim 1, wherein the server input/output processor and the storage array input/output processor run on a real-time operating system (RTOS).

9. An input/output processor for a system within a network cluster, comprising:
a health monitoring and heartbeat logic circuit to monitor the system and to generate a system down message when the system is down;
a failure/recovery logic circuit to designate a status of the system and to allow the system to take over for a failed system;
a cluster node add/remove logic circuit to allow addition or removal of systems without taking the network cluster offline; and
a cluster membership discovery/reconcile logic circuit to establish the network cluster and to ensure cluster failover support for the systems within the network cluster.

10. The input/output processor according to claim 9, wherein the system is a server system.

11. The input/output processor according to claim 9, wherein the system is a storage array.

12. The input/output processor according to claim 9, wherein the system is a storage router.

13. The input/output processor according to claim 9, wherein data and the system down message transmitted to and from the input/output processor travel along a connection between the input/output processor and a second input/output processor of a second system.

14. The input/output processor according to claim 9, wherein the status is selected from the group consisting of active, failed, recovered, and standby.

15. The input/output processor according to claim 9, wherein the input/output processor runs on a real-time operating system (RTOS).

16. The input/output processor according to claim 9, wherein the system includes a cluster management information base (MIB) that is accessible to the input/output processor.

17. A network cluster, comprising:
a first server system having a first server input/output processor to monitor the first server system and to issue a first server down message when the first server system is down;
a first storage array having a first storage array input/output processor to monitor the first storage array and to issue a first storage array down message when the first storage array is down;
a second server system having a second server input/output processor to monitor the second server system and to issue a second server down message when the second server system is down;
a second storage array having a second storage array input/output processor to monitor the second storage array and to issue a second storage array down message when the second storage array is down; and
a storage router interconnecting the first server system, the second server system, the first storage array, and the second storage array, the storage router having a storage router input/output processor to monitor the storage router and to issue a storage router down message when the storage router is down, wherein the first server system, the second server system, the first storage array, and the second storage array each have a cluster management information base (MIB).

18. The network cluster according to claim 17, wherein data transmitted to and from the first server system and the first server down message travel along a connection between the first server system and the storage router.

19. The network cluster according to claim 17, wherein data transmitted to and from the first storage array and the first storage array down message travel along a connection between the first storage array and the storage router.

20. The network cluster according to claim 17, wherein data transmitted to and from the second server system and the second server down message travel along a connection between the second server system and the storage router.

21. The network cluster according to claim 17, wherein data transmitted to and from the second storage array and the second storage array down message travel along a connection between the second storage array and the storage router.

22. The network cluster according to claim 17, wherein the first server system, the first storage array, the second server system, and the second storage array are members of the network cluster.

23. The network cluster according to claim 17, wherein the first server system is connected to the storage router via a Gig-Ethernet Internet Small Computer System Interface (iSCSI) connection.

24. The network cluster according to claim 17, wherein the second server system is connected to the storage router via a Gig-Ethernet Internet Small Computer System Interface (iSCSI) connection.

25. The network cluster according to claim 17, wherein the first storage array is connected to the storage router via a Gig-Ethernet Internet Small Computer System Interface (iSCSI) connection.

26. The network cluster according to claim 17, wherein the second storage array is connected to the storage router via a Gig-Ethernet Internet Small Computer System Interface (iSCSI) connection.

27. The system according to claim 17, wherein the storage router further includes a second storage router input/output processor, the storage router input/output processor being in communication with the first server input/output processor and the second server input/output processor, and the second router input/output processor being in communication with the first storage array input/output processor and the second storage array input/output processor.

28. The system according to claim 17, wherein the first server input/output processor, the second server input/output processor, the first storage array input/output processor, and the second storage array input/output processor run on a real-time operating system (RTOS).
